(19) United States
(12) Patent Application Publication
(10) Pub. No.: US 2025/0109453 A1
(43) Pub. Date: Apr. 3, 2025

(54) NON-ORIENTED ELECTRICAL STEEL SHEET AND METHOD FOR MANUFACTURING SAME

(71) Applicant: POSCO Co., Ltd, Pohang-si, Gyeongsangbuk-do (KR)

(72) Inventors: Jae-Hoon KIM, Pohang-si, Gyeongsangbuk-do (KR); Su-Yong SHIN, Pohang-si, Gyeongsangbuk-do (KR); Yunsu KIM, Pohang-si, Gyeongsangbuk-do (KR)

(73) Assignee: POSCO Co., Ltd, Pohang-si, Gyeongsangbuk-do (KR)

(21) Appl. No.: 18/723,234

(22) PCT Filed: Dec. 20, 2022
(86) PCT No.: PCT/KR2022/020907

§ 371 Date: Jul. 25, 2024

(30) Foreign Application Priority Data
Dec. 22, 2021 (KR) 10-2021-0184550

(51) Int. Cl. C21D 9/46; C21D 6/00; C21D 8/12; C22C 38/00; C22C 38/02; C22C 38/04; C22C 38/06; C22C 38/20; C22C 38/34; C22C 38/60; H01F 1/153

(52) U.S. Cl. CPC C21D 9/46; C21D 6/002; C21D 6/005; C21D 6/008; C21D 8/1222; C21D 8/1233; C21D 8/1261; C22C 38/008; C22C 38/02; C22C 38/04; C22C 38/06; C22C 38/20; C22C 38/34; C22C 38/60; H01F 1/153; C22C 2202/02

(57) ABSTRACT

A non-oriented electrical steel sheet according to an embodiment of the present invention contains, by wt %: 3.1 to 3.8% of Si, 0.5 to 1.5% of Al, 0.3 to 1.5% of Mn, 0.01 to 0.15% of Cr, 0.003 to 0.08% of Sn, 0.003 to 0.06% of Sb, and a balance of Fe and inevitable impurities.

The non-oriented electrical steel sheet according to an embodiment of the present invention includes a surface portion present from a surface of the steel sheet to 1/10 of a thickness of the steel sheet in a direction from the surface of the steel sheet toward an inside of the steel sheet, and a central portion, and when punching the non-oriented electrical steel sheet, a length of a plastically deformed portion may be 100 μm or less. In this case, the plastically deformed portion refers to a length of a portion from a punched end portion where hardness of the surface portion exceeds 1.10 times that of the central portion.

### TECHNICAL FIELD

An embodiment of the present invention relates to a non-oriented electrical steel sheet and a method for manufacturing the same. Specifically, an embodiment of the present invention relates to a non-oriented electrical steel sheet and a method for manufacturing the same capable of ensuring magnetic properties and extending the life of a mold in a high-alloy system by adjusting a dew point in an initial temperature raising treatment during cold-rolled sheet annealing depending on an alloy composition in a steel sheet and a surface roughness of a cold-rolled sheet, thereby forming an appropriate surface portion in the steel sheet.

### BACKGROUND ART

Efficient use of electrical energy is becoming a big issue for improving the global environment, such as energy saving, a reduction in fine dust generation, and a reduction in greenhouse gas. Since 50% or more of the entire electric energy that is currently being generated is consumed in electric motors, high efficiency of the electric motors is indispensable to achieve efficient use of electricity. Recently, along with rapid development of the field of eco-friendly vehicles (hybrid vehicle, plug-in hybrid vehicle, electric vehicle, and fuel cell vehicle), an interest in high-efficiency drive motor is rapidly increasing, and awareness and government regulations for high efficiency such as high-efficiency motors for home appliances and super-premium motors for heavy electric appliances have continued. Therefore, a demand for efficient use of electric energy is higher than ever.

On the other hand, in order to achieve high efficiency of electric motors, optimization is significantly important in all areas from material selection to design, assembly, and control. In terms of materials, there is a high demand for low iron loss and high strength of electrical steel sheets. The high-frequency low iron loss characteristics are significantly important for drive motors of vehicles and motors of air conditioning compressors that should be driven not only in the commercial frequency region but also in the high frequency region. In addition, high strength characteristics are also important so as to ensure stability during high-speed rotation. To this end, there is known a method in which a large amount of elements such as Si, Al, and Mn are added to secure high-frequency low iron loss and high strength at the same time.

However, adding a large amount of elements such as Si, Al, and Mn causes a reduction in the life of a mold during the punching process of the motor manufacturing process, so it is necessary to improve material characteristics so as to increase the life of the mold in such a high-alloy system.

### DISCLOSURE

### Technical Problem

An embodiment of the present invention attempts to provide a non-oriented electrical steel sheet and a method for manufacturing the same. Specifically, an embodiment of the present invention attempts to provide a non-oriented electrical steel sheet and a method for manufacturing the same capable of ensuring magnetic properties and simultaneously extending the life of a mold in a high-alloy system by adjusting a dew point in an initial temperature raising treatment during cold-rolled sheet annealing depending on an alloy composition in a steel sheet and a surface roughness of a cold-rolled sheet, thereby forming an appropriate surface portion in the steel sheet.

### Technical Solution

A non-oriented electrical steel sheet according to an embodiment of the present invention contains, by wt %: 3.1 to 3.8% of Si, 0.5 to 1.5% of Al, 0.3 to 1.5% of Mn, 0.01 to 0.15% of Cr, 0.003 to 0.08% of Sn, 0.003 to 0.06% of Sb, and a balance of Fe and inevitable impurities.

The non-oriented electrical steel sheet according to an embodiment of the present invention may include a surface portion present from a surface of the steel sheet to 1/10 of a thickness of the steel sheet in a direction from the surface of the steel sheet toward an inside of the steel sheet, and a central portion, wherein when the non-oriented electrical steel sheet is punched, a length of a plastically deformed portion may be 100 μm or less. In this case, the plastically deformed portion refers to a length of a portion from a punched end portion where hardness of the surface portion exceeds 1.10 times that of the central portion.

The non-oriented electrical steel sheet according to an embodiment of the present invention may satisfy Formula 1 below.

$$0.03 \leq ( [ Cr ] + [ Sn ] + [ Sb ] ) \leq 0.2 \qquad [ Formula 1 ]$$

(in Formula 1, [Cr], [Sn], and [Sb] indicate contents (wt %) of Cr, Sn, and

Sb, respectively.) The non-oriented electrical steel sheet according to an embodiment of the present invention may further contain@@@0.01 to 0.2 wt % of Cu.

The non-oriented electrical steel sheet according to an embodiment of the present invention may further contain one or more of@@@0.08 wt % or less of P, 0.03 wt % or less of Mo, 0.0050 wt % or less of B, 0.0050 wt % or less of Ca, and 0.0050 wt % or less of Mg.

The non-oriented electrical steel sheet according to an embodiment of the present invention may further contain 0.005 wt % or less of one or more of C, N, S, Ti, Nb, and V.

A surface roughness of the steel sheet may be 0.15 to 0.35 μm.

The hardness of the surface portion may be 1.05 to 1.10 times that of the central portion.

A method for manufacturing a non-oriented electrical steel sheet according to an embodiment of the present invention includes: manufacturing a hot-rolled sheet by hot rolling a slab containing, by wt %: 3.1 to 3.8% of Si, 0.5 to 1.5% of Al, 0.3 to 1.5% of Mn, 0.01 to 0.15% of Cr, 0.003 to 0.08% of Sn, 0.003 to 0.06% of Sb, and a balance of Fe and inevitable impurities, and satisfying Formula 1 below; manufacturing a cold-rolled sheet by cold rolling the hot-rolled sheet; and subjecting the cold-rolled sheet to cold-rolled sheet annealing.

The annealing the cold-rolled sheet includes a first temperature raising treatment of raising a temperature of the cold-rolled sheet from 200° C. to 500° C., a second temperature raising treatment of raising the temperature of the cold-rolled sheet from higher than 500° C. to lower than a soaking temperature, and a soaking treatment, and Formula 2 below is satisfied.

$$[ Formula 2 ]$$

$$\{ ( [ Cr ] + [ Sn ] + [ Sb ] ) \times [ sheet thickness ] \} / \{ ( [ Si ] + [ Al ] ) \times [ sheet roughness ] \} \leq [ DP ]$$

(in Formula 2, [Si], [Al], [Cr], [Sn], and [Sb] indicate contents (wt %) of Si, Al, Cr, Sn, and Sb, respectively, [sheet thickness] indicates a sheet thickness (μm) of the cold-rolled sheet after the manufacturing the cold-rolled sheet, [sheet roughness] indicates a surface roughness (μm) of the cold-rolled sheet after the manufacturing the cold-rolled sheet, and [DP] indicates a dew point (° C.) in the first temperature raising treatment.)

After the manufacturing the cold-rolled sheet, the surface roughness of the cold-rolled sheet may be 0.15 to 0.35 μm.

The dew point in the first temperature raising treatment may be 0 to 50° C.

The dew point in the second temperature raising treatment and the soaking treatment may be −30° C. to 10° C.

### Advantageous Effects

The non-oriented electrical steel sheet according to an embodiment of the present invention can secure magnetic properties and simultaneously extend the life of a mold in a high-alloy system.

When the non-oriented electrical steel sheet according to an embodiment of the present invention is manufactured for a motor, the motor can be driven with a small current even during high-speed rotation, and thus the efficiency of the motor is excellent.

Ultimately, the non-oriented electrical steel sheet according to an embodiment of the present invention contributes to the manufacture of motors for eco-friendly vehicles, high-efficiency motors for home appliances, and super-premium electric motors.

### DESCRIPTION OF THE DRAWINGS

FIG. 1 is a schematic side cross-sectional view of a non-oriented electrical steel sheet according to an embodiment of the present invention.

FIG. 2 is a schematic view for illustrating a plastically deformed portion when punching a non-oriented electrical steel sheet.

### MODE FOR INVENTION

The terms such as first, second and third are used for describing, but are not limited to, various parts, components, regions, layers, and/or sections. These terms are used only to discriminate one part, component, region, layer or section from another part, component, region, layer or section. Therefore, a first part, component, region, layer or section described below may be referred to as a second part, component, region, layer or section without departing from the scope of the present invention.

The technical terms used herein are set forth only to mention specific embodiments and are not intended to limit the present invention. Singular forms used herein are intended to include the plural forms as long as phrases do not clearly indicate an opposite meaning. In the present specification, the term “including” is intended to embody specific characteristics, regions, integers, steps, operations, elements and/or components, but is not intended to exclude presence or addition of other characteristics, regions, integers, steps, operations, elements, and/or components.

When a part is referred to as being “above” or “on” another part, it may be directly above or on the other part or an intervening part may also be present. In contrast, when a part is referred to as being “directly above” another part, there is no intervening part present.

Unless otherwise defined, all terms including technical and scientific terms used herein have the same meanings as the meanings generally understood by one skilled in the art to which the present invention pertains. Terms, such as those defined in commonly used dictionaries, are to be interpreted as having meanings consistent with the relevant technical literature and the present disclosure, and are not to be interpreted as having idealized or overly formal meanings unless expressly so defined herein.

In addition, unless otherwise stated, % means wt %, and 1 ppm is 0.0001 wt %.

In an embodiment of the present invention, further including an additional element means that the additional element is included by replacing a balance of iron (Fe) by an amount of additional element added.

Hereinafter, embodiments of the present invention will be described in detail so that one skilled in the art to which the present invention pertains can easily implement the present invention. As those skilled in the art would realize, the described embodiments may be modified in various different ways, all without departing from the spirit or scope of the present invention.

In an embodiment of the present invention, an appropriate surface portion is formed in a steel sheet by adjusting a dew point in an initial temperature raising treatment during cold-rolled sheet annealing depending on an alloy composition in the steel sheet and a surface roughness of a cold-rolled sheet, resulting in ensuring magnetic properties and simultaneously extending the life of a mold in a high-alloy system.

A non-oriented electrical steel sheet according to an embodiment of the present invention contains, by wt %: 3.1 to 3.8% of Si, 0.5 to 1.5% of Al, 0.3 to 1.5% of Mn, 0.01 to 0.15% of Cr, 0.003 to 0.08% of Sn, 0.003 to 0.06% of Sb, and a balance of Fe and inevitable impurities.

First, the reason for limiting the components of the non-oriented electrical steel sheet will be described.

### Si: 3.10 to 3.80 wt %

Silicon (Si) serves to lower iron loss by increasing resistivity of a material and to increase strength. If Si is added too little, the effect of improving high-frequency iron loss and strength is insufficient. If Si is added excessively, the hardness of a material increases, so that the productivity and punching property become inferior. More specifically, Si may be included in an amount of 3.20 to 3.60 wt %.

### Al: 0.50 to 1.50 wt %

Aluminum (Al) serves to lower iron loss by increasing resistivity of a material and to improve strength. If Al is added too little, it is less effective in reducing high-frequency iron loss and improving strength, and fine nitrides may be formed to deteriorate the magnetic property. On the other hand, if Al is added excessively, it may cause problems in all processes such as steelmaking and continuous casting, resulting in a significant reduction in productivity. Therefore, Al may be added within the above-described range. More specifically, Al may be included in an amount of 0.50 to 1.30 wt %.

### Mn: 0.3 to 1.5 wt %

Manganese (Mn) is an element that serves to improve iron loss by increasing resistivity of a material and to form sulfides. If Mn is added too little, MnS may precipitate finely and deteriorate the magnetic property. On the other hand, if Mn is added excessively, the magnetic flux density may be reduced by promoting formation of a {111}texture that is disadvantageous to the magnetic property. Therefore, Mn may be added within the above-described range. More specifically, Mn may be included in an amount of 0.5 to 1.4 wt %. More specifically, Mn may be included in an amount of 1.0 to 1.3 wt %.

### Resistivity: 45 μΩ·Cm or Higher

The resistivity is a value calculated from “13.25+11.3×([Si]+[Al]+[Mn]/2)”. In this case, [Si], [Al], and [Mn] indicate contents (wt %) of Si, Al, and Mn, respectively. The higher the resistivity, the lower the iron loss. If the resistivity is too low, the iron loss is low, making it difficult to use the non-oriented electrical steel sheet for a high-efficiency motor. More specifically, the resistivity may be 50 to 80 μΩ·cm. More specifically, the resistivity may be 60 to 75 μΩ·cm.

### Cr: 0.010 to 0.150 wt %, Sn: 0.003 to 0.080 wt %, and Sb: 0.003 to 0.060 wt %

Chromium (Cr), tin (Sn), and antimony (Sb) segregate on the surface when annealing conditions are appropriately adjusted. The segregation occurs properly only when Cr, Sn, and Sb are included within the above-described ranges. If the contents thereof are below the ranges, there is no surface segregation effect, and if they are added excessively, the brittleness of a material will be increased to cause problems. More specifically, Cr: 0.010 to 0.100 wt %, Sn: 0.005 to 0.050 wt %, and Sb: 0.005 to 0.030 wt % may be contained.

The non-oriented electrical steel sheet according to an embodiment of the present invention may satisfy Formula 1.

$$0.03 \leq ( [ Cr ] + [ Sn ] + [ Sb ] ) \leq 0.2 \qquad [ Formula 1 ]$$

(in Formula 1, [Cr], [Sn], and [Sb] indicate contents (wt %) of Cr, Sn, and Sb, respectively.)

Formula 1 indicates a range in which the surface segregation occurs most efficiently. If the value is below the lower limit of Formula 1, the dew point should be further lowered for efficient segregation, which may reduce the productivity. If the value is above the upper limit of Formula 1, rolling may become impossible. More specifically, the value of Formula 1 may be 0.030 to 0.100.

The non-oriented electrical steel sheet according to an embodiment of the present invention may further contain 0.01 to 0.2 wt % of Cu.

### Cu: 0.01 to 0.20 wt %

Copper (Cu) serves to form sulfides together with Mn. If Cu is added more or added too little, CuMnS may precipitate finely and deteriorate the magnetic property. If Cu is added excessively, high-temperature brittleness may occur and cracks may be formed during continuous casting or hot rolling. More specifically, Cu may be included in an amount of 0.01 to 0.10 wt %.

The non-oriented electrical steel sheet according to an embodiment of the present invention may further contain one or more of 0.08 wt % or less of P, 0.03 wt % or less of Mo, 0.0050 wt % or less of B, 0.0050 wt % or less of V, 0.0050 wt % or less of Ca, 0.0050 wt % or less of Nb, and 0.0050 wt % or less of Mg.

### P: 0.08 wt % or Less

Phosphorus (P) is concentrated in the surface and serves to control the fraction of the internal oxidation layer. If the amount of P added is too small, it may be difficult to form a uniform internal oxidation layer. If the amount of P added is too large, the melting point of the Si-based oxide may vary and an internal oxidation layer may be rapidly formed. Therefore, the content of P may be controlled within the above-described range. More specifically, P may be included in an amount of 0.005 to 0.07 wt %.

The non-oriented electrical steel sheet according to an embodiment of the present invention may further contain one or more of@@@0.03 wt % or less of Mo, 0.0050 wt % or less of B, 0.0050 wt % or less of Ca, and 0.0050 wt % or less of Mg.

Since these elements react with inevitably included C, S, N, and the like to form fine carbides, nitrides, or sulfides, which may adversely affect the magnetic properties, the upper limits thereof may be limited as described above.

### Other Impurities

In addition to the elements described above, inevitable impurities such as carbon (C), sulfur (S), nitrogen (N), titanium (Ti), niobium (Nb), and vanadium (V) may be included.

C, N, and Ti may be limited because they form carbonitrides to interfere with magnetic domain movement. S can form sulfides and deteriorate grain growth, so the upper limit may be limited. These elements may be included in an amount of 0.0040 wt % or less, respectively.

N combines with Ti, Nb, and V to form nitride and serves to reduce grain growth.

C reacts with N, Ti, Nb, V, and the like to form fine carbides and serves to interfere with grain growth and magnetic domain movement.

S forms sulfide and deteriorates grain growth.

As such, when the impurity elements are further included, one or more of C, S, N, Ti, Nb and V may be included in an amount of 0.005 wt % or less, respectively.

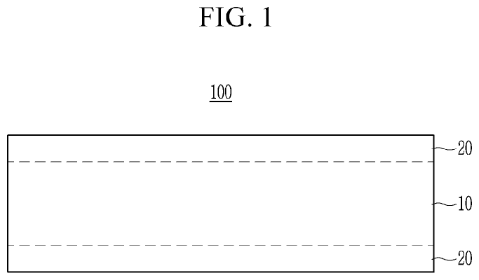

FIG. 1 is schematic side cross-sectional view of a non-oriented electrical steel sheet according to an embodiment of the present invention. The non-oriented electrical steel sheet shown in FIG. 1 is only for illustrating the present invention, and the present invention is not limited thereto. Therefore, the structure of the non-oriented electrical steel sheet can be modified in various ways.

As shown in FIG. 1, a non-oriented electrical steel sheet 100 according to an embodiment of the present invention includes a surface portion 20 present from a surface of the steel sheet to 1/10 of a thickness of the steel sheet in a direction from the surface of the steel sheet toward an inside of the steel sheet and a central portion 10.

A surface roughness of the steel sheet may be 0.15 to 0.35 μm. If the surface roughness of the steel sheet increases, residual oxygen increases on the surface of the steel sheet, making it difficult to control the dew point. If the surface roughness of the steel sheet is too low, the rolling productivity may decrease.

The hardness of the surface portion 20 may be 1.05 to 1.10 times the hardness of the central portion 10. In an embodiment of the present invention, a large amount of alloy components such as Si, Al, and Mn are added, and these alloy components are concentrated in the surface portion 20 during the manufacturing process, resulting in an increase in the hardness of the surface portion 20 compared to that of the central portion 10. In an embodiment of the present invention, by adjusting the precipitation characteristics and oxidation characteristics of the surface portion 20 to appropriately adjust the hardness, the life of a mold can be extended even in a high-alloy system. The hardness is Vickers hardness, and may be measured at a load of 10 g using a micro Vickers hardness tester. More specifically, the hardness of the surface portion 20 may be 1.06 to 1.09 times the hardness of the central portion 10.

The hardness of the surface portion 20 may be 230 to 285, and the hardness of the central portion 10 may be 200 to 265. More specifically, the hardness of the surface portion 20 may be 245 to 275, and the hardness of the central portion 10 may be 220 to 255.

In the non-oriented electrical steel sheet 100, the hardness may be constant on the entire surface of the steel sheet. However, when punching is performed, the hardness of the punched end portion increases due to the punching. In particular, the hardness of the surface portion 20 increases significantly compared to the central portion 10, which causes a decrease in the life of a mold. In an embodiment of the present invention, the precipitation characteristics and oxidation characteristics of the surface portion 20 can be adjusted to suppress areas where the hardness of the surface portion 20 increases during punching. This minimizes the deterioration in iron loss due to punching. Specifically, when punching the non-oriented electrical steel sheet, a length of a plastically deformed portion may be 100 μm or less. In this case, the plastically deformed portion refers to a length of a portion from the punched end portion where the hardness of the surface portion 20 exceeds 1.10 times that of the central portion 10.

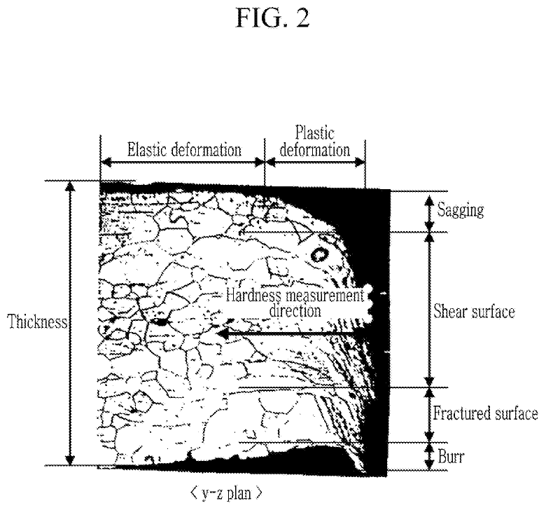

FIG. 2 shows a method of measuring the length of the plastically deformed portion. When a steel sheet is punched, a punched end portion occurs as shown in the right end portion of FIG. 2. At the punched end portion, sagging, shear surface, fractured surface and burr are formed. While measuring the hardness from the punched end portion toward the opposite end portion, a length of the portion where the hardness of the surface portion 20 exceeds 1.10 times that of the central portion 10 is measured. This is referred to as the length of the plastically deformed portion. More specifically, the length of the plastically deformed portion may be 90 μm or less. The lower limit is not particularly limited, but may be 50 μm or greater. When punching, the clearance is set to 8% of the thickness so that the length of the plastically deformed portion can be measured.

The non-oriented electrical steel sheet according to an embodiment of the present also has excellent magnetic characteristics. Specifically, after punching, the iron loss (W_{10/400}) of the non-oriented electrical steel sheet may be 13.5 W/kg or less. Iron loss (W_{10/400}) is iron loss when a magnetic flux density of 1.0T is induced at a frequency of 400 HZ. More specifically, the iron loss (W_{10/400}) of the non-oriented electrical steel sheet may be 10.0 to 12.5 W/kg.

A method for manufacturing a non-oriented electrical steel sheet according to an embodiment of the present invention includes the steps of: manufacturing a hot-rolled sheet by hot rolling a slab containing, by wt %: 3.1 to 3.8% of Si, 0.5 to 1.5% of Al, 0.3 to 1.5% of Mn, 0.01 to 0.15% of Cr, 0.003 to 0.08% of Sn, 0.003 to 0.06% of Sb, and a balance of Fe and inevitable impurities; manufacturing a cold-rolled sheet by cold rolling the hot-rolled sheet; and subjecting the cold-rolled sheet to cold-rolled sheet annealing.

$$0.03 \leq ( [ Cr ] + [ Sn ] + [ Sb ] ) \leq 0.2 \qquad [ Formula 1 ]$$

Below, each step will be described in detail.

First a slab is prepared. The reason for limiting the addition ratio of each composition in the slab is the same as the reason for limiting the composition of the non-oriented electrical steel sheet described above, so redundant descriptions will be omitted. Since the composition of the slab does not substantially change during manufacturing processes such as hot rolling, hot-rolled sheet annealing, cold rolling, and cold-rolled sheet annealing, which will be described below, the composition of the slab and the composition of the non-oriented electrical steel sheet are substantially the same.

The slab may be heated before the step of manufacturing the hot-rolled sheet. Specifically, the slab is charged into a heating furnace and heated to 1100° C. to 1250° C. When heated at a temperature exceeding 1250° C., the precipitates may be re-dissolved and finely precipitate after hot rolling.

The heated slab is manufactured into a hot-rolled sheet by hot rolling to a thickness of 2 to 2.3 mm. In the step of manufacturing the hot-rolled sheet, the finishing rolling temperature may be 800° C. to 1000° C.

After the step of manufacturing the hot-rolled sheet, the step of subjecting the hot-rolled sheet to hot-rolled sheet annealing may be further included. In this case, the hot-rolled sheet annealing temperature may be 850° C. to 1150° C. If the hot-rolled sheet annealing temperature is lower than 850° C., the structure does not grow or grows finely, so the effect of increasing a magnetic flux density is small. If the annealing temperature exceeds 1150° C., the magnetic properties rather deteriorate, and the shape of the plate may be deformed to deteriorate rolling workability. More specifically, the temperature range may be 950° C. to 1125° C. More specifically, the annealing temperature of the hot-rolled sheet is 900° C. to 1100° C. The hot-rolled sheet annealing is performed so as to increase the orientation advantageous to the magnetic property as needed, and may also be omitted.

Next, the hot-rolled sheet is pickled and cold rolled to a predetermined thickness. The hot-rolled plate may be cold rolled to a final thickness of 0.2 to 0.65 mm by applying a reduction ratio of 70 to 95% that may vary depending on the thickness of the hot-rolled sheet. In order to meet the reduction ratio, the cold rolling may be performed once or may be performed two or more times with intermediate annealing therebetween.

After the step of manufacturing the cold-rolled sheet, the surface roughness of the cold-rolled sheet may be 0.15 to 0.35 μm. If the surface roughness of the cold-rolled sheet increases, residual oxygen increases on the surface of the cold-rolled sheet, making it difficult to control the dew point. If the surface roughness of the cold-rolled sheet is too low, the rolling productivity may decrease.

The cold-rolled sheet is subjected to cold-rolled sheet annealing.

The annealing the cold-rolled sheet includes a first temperature raising treatment of raising a temperature of the cold-rolled sheet from 200° C. to 500° C., a second temperature raising treatment of raising the temperature of the cold-rolled sheet from higher than 500° C. to lower than a soaking temperature, and a soaking treatment, and Formula 2 below is satisfied.

$$[ Formula 2 ]$$

$$\{ ( [ Cr ] + [ Sn ] + [ Sb ] ) \times [ sheet thickness ] \} / \{ ( [ Si ] + [ Al ] ) \times [ sheet roughness ] \} \leq [ DP ]$$

(in Formula 2, [Si], [Al], [Cr], [Sn], and [Sb] indicate contents (wt %) of Si, Al, Cr, Sn, and Sb, respectively, [sheet thickness] indicates a sheet thickness (μm) of the cold-rolled sheet after the manufacturing the cold-rolled sheet, [sheet roughness] indicates a surface roughness (μm) of the cold-rolled sheet after the manufacturing the cold-rolled sheet, and [DP] indicates a dew point (° C.) in the first temperature raising treatment.)

If the dew point in the first temperature raising treatment does not satisfy Formula 2, that is, if the dew point is not sufficiently high, an amount of oxidation on the surface portion 10 becomes greater than an amount of segregation, making it difficult to properly adjust the hardness of the surface portion 10. Specifically, the dew point in the first temperature raising treatment may be 0 to 30° C.

The second temperature raising treatment raises the temperature of the cold-rolled sheet from higher than 500° C. to lower than a soaking temperature. The dew point in the second temperature raising treatment may be −30° C. to 10° C. In the second temperature raising treatment, the dew point may be adjusted to be lower than that in the first temperature raising treatment so as to prevent oxidation. Specifically, the dew point in the second temperature raising treatment may be −30° C. to 0° C. More specifically, the dew point in the second temperature raising treatment may be −30° C. to −10° C. More specifically, the dew point in the second temperature raising treatment may be lower than that in the first temperature raising treatment by 10° C. to 60° C.

The soaking treatment is a process in which the temperature is maintained uniformly without variation after a soaking temperature is reached. The soaking treatment may be performed at a soaking temperature of 800° C. to 1070° C. If the soaking temperature is too low, recrystallization cannot sufficiently occur, and if the soaking temperature is too high, the grain size may become too large, resulting in deterioration in high-frequency iron loss. The soaking treatment may be adjusted in the same manner as the dew point in the second temperature raising treatment. The soaking time may be 10 seconds to 5 minutes.

Thereafter, a step of forming an insulating layer may be further included. Since the method of forming the insulating layer is widely known in the field of the non-oriented electrical steel sheet technology, detailed description is omitted.

Below, preferred Examples of the present invention and Comparative Examples will be described. However, the following Examples are merely preferred examples of the present invention, and the present invention is not limited to the following Examples.

### Example 1

Slabs composed as shown in Table 1 below were prepared. The contents of C, S, N, Ti, Nb, V, and the like other than the components listed in Table 1 were all controlled to 0.003 wt % or less, and the balance was Fe. The slab was heated to 1150° C. and hot-finish rolled at 850° C. to produce a hot-rolled sheet with a thickness of 2.0 mm. The hot-rolled sheet was annealed at 1100° C. for 4 minutes and then pickled. Then, cold rolling was performed to prepare the cold-rolled sheet with the sheet thickness and surface roughness as summarized in Table 2, and then cold-rolled sheet annealing was performed.

The dew point in the first temperature raising treatment was adjusted as summarized in Table 2 below, and the dew points in the second temperature raising treatment and the soaking treatment were adjusted to about −10° C. The soaking temperature in the soaking treatment was set to 970° C. and maintained for 3 minutes.

The hardness of the surface portion was measured by grinding the surface to 1/20 of the total thickness of the steel sheet with soft sandpaper of #1000 or finer and then performing fine polishing and electropolishing to prevent surface stress from being induced due to polishing.

The hardness of the central portion was measured by grinding the surface to ½ of the total thickness of the steel sheet with soft sandpaper of #1000 or finer and then performing fine polishing and electropolishing to prevent surface stress from being induced due to polishing.

Five specimens in 60 mm wide×60 mm long size were cut for each specimen, iron loss in a rolling direction and a direction perpendicular to the rolling direction was measured with a single sheet tester, and the average value thereof is listed.

The plastically deformed portion was cut as above, and the tolerance was set to 8% of the thickness. While moving for each 5 μm from the punched end portion, the length of a portion where the ratio of the hardness of the surface portion and the hardness of the central portion exceeds 1.10 was measured.

The hardness, the iron loss (W_{10/400}), and the length of the plastically deformed portion are summarized in Table 3.

TABLE 1

| | | | | Resistivity | | | | | |
|---|---|---|---|---|---|---|---|---|---|
| (wt %) | Si | Al | Mn | (μΩ · cm) | Cu | Cr | Sn | Sb | Cr + Sn + Sb |
| 1 | 3.20 | 0.50 | 1.2 | 62 | 0.01 | 0.010 | 0.030 | 0.010 | 0.050 |
| 2 | 3.30 | 0.80 | 1.0 | 65 | 0.08 | 0.080 | 0.010 | 0.010 | 0.100 |
| 3 | 3.50 | 0.50 | 0.2 | 60 | 0.05 | 0.010 | 0.005 | 0.005 | 0.020 |
| 4 | 2.80 | 0.30 | 0.3 | 50 | 0.02 | 0.020 | 0.030 | 0.004 | 0.054 |
| 5 | 3.60 | 1.30 | 1.0 | 74 | 0.08 | 0.060 | 0.010 | 0.010 | 0.080 |
| 6 | 3.20 | 0.90 | 1.4 | 67 | 0.10 | 0.010 | 0.010 | 0.010 | 0.030 |
| 7 | 3.10 | 1.50 | 1.5 | 74 | 0.07 | 0.005 | 0.010 | 0.010 | 0.025 |
| 8 | 3.45 | 0.75 | 0.5 | 64 | 0.06 | 0.100 | 0.080 | 0.060 | 0.240 |
| 9 | 3.80 | 0.50 | 0.3 | 64 | 0.02 | 0.030 | 0.020 | 0.040 | 0.090 |
| 10 | 3.30 | 0.60 | 0.5 | 60 | 0.02 | 0.003 | 0.030 | 0.030 | 0.063 |
| 11 | 3.20 | 0.80 | 0.8 | 63 | 0.02 | 0.020 | 0.001 | 0.050 | 0.071 |
| 12 | 3.30 | 0.50 | 1.2 | 63 | 0.02 | 0.020 | 0.020 | 0.001 | 0.041 |

TABLE 2

| | | | | Dew point | |
|---|---|---|---|---|---|
| | | | | in first | |
| | | | | temperature | |
| | Surface | Steel sheet | | raising | Is |
| | roughness | thickness | Left side of | treatment | Formula 2 |
| Classification | (μm) | (μm) | Formula 2 | (° C.) | satisfied? |
| 1 | 0.15 | 250 | 22.52 | 20 | ◯ |
| 2 | 0.20 | 250 | 30.49 | 40 | X |
| 3 | 0.25 | 250 | 5.00 | 0 | ◯ |
| 4 | 0.30 | 250 | 14.52 | 10 | ◯ |
| 5 | 0.35 | 250 | 11.66 | 10 | ◯ |
| 6 | 0.28 | 200 | 5.23 | 2 | ◯ |
| 7 | 0.32 | 200 | 3.40 | 1 | ◯ |
| 8 | 0.24 | 250 | 59.52 | 20 | ◯ |
| 9 | 0.40 | 250 | 13.08 | 25 | X |
| 10 | 0.31 | 300 | 15.63 | 10 | ◯ |
| 11 | 0.25 | 250 | 17.75 | 12 | ◯ |
| 12 | 0.24 | 250 | 11.24 | 8 | ◯ |

TABLE 3

| | | | | | Length of | |
|---|---|---|---|---|---|---|
| | Hardness | | | Iron | plastically | |
| | of | Hardness | | loss | deformed | |
| | surface | of central | Hardness | (W_{10/400}, | portion | |
| Classification | portion | portion | ratio | W/kg) | (μm) | Remarks |
| 1 | 250 | 230 | 1.09 | 12.2 | 80 | Example |
| 2 | 240 | 235 | 1.02 | 14.5 | 220 | Comparative |
| | | | | | | Example |
| 3 | 255 | 254 | 1.00 | 15.4 | 250 | Comparative |
| | | | | | | Example |
| 4 | 210 | 209 | 1.00 | 16.5 | 270 | Comparative |
| | | | | | | Example |
| 5 | 270 | 254 | 1.06 | 11.8 | 90 | Example |
| 6 | 248 | 231 | 1.07 | 12.4 | 85 | Example |
| 7 | 236 | 230 | 1.03 | 14.7 | 235 | Comparative |
| | | | | | | Example |
| 8 | 260 | 262 | 0.99 | 14.9 | 215 | Comparative |
| | | | | | | Example |
| 9 | 275 | 270 | 1.02 | 15.3 | 245 | Comparative |
| | | | | | | Example |
| 10 | 238 | 235 | 1.01 | 16.2 | 330 | Comparative |
| | | | | | | Example |
| 11 | 245 | 240 | 1.02 | 13.5 | 180 | Comparative |
| | | | | | | Example |
| 12 | 241 | 240 | 1.00 | 13.8 | 205 | Comparative |
| | | | | | | Example |

As shown in Tables 1 to 3, it can be confirmed that in the Examples that satisfy the alloy composition and manufacturing process conditions, the precipitation characteristics and oxidation characteristics of the surface portion are appropriately controlled, the iron loss is improved, and the length of the plastically deformed portion is short.

In specimen Nos. 2 and 9, it can be confirmed that Formula 2 is not satisfied, and the plastically deformed portion is long, resulting in deterioration in iron loss.

In specimen Nos. 3 and 4, it can be confirmed that small amounts of alloy components such as Si, Al, and Mn were added, resulting in deterioration in iron loss.

In specimen Nos. 7, 10, 11, and 12, it can be confirmed that the amounts of Cr, Sn, and Sb added were small, resulting in an increase in the length of the plastically deformed portion and deterioration in the iron loss.

In specimen No. 8, it can be confirmed that Cr, Sn, and Sb were added excessively, resulting in an increase in the length of the plastically deformed portion and deterioration in the iron loss.

It will be understood by one skilled in the art to which the present invention belongs that the present invention is not limited to the above embodiments, but can be manufactured in a variety of different forms, and can be implemented in other specific forms without changing the technical spirit or essential features of the present invention. Therefore, the embodiments described above should be understood as illustrative in all respects and not for purposes of limitation.

### REFERENCE SIGNS LIST

100: non-oriented electrical steel sheet,
10: central portion,
20: surface portion

1. A non-oriented electrical steel sheet according to an embodiment of the present invention contains, by wt %: 3.1 to 3.8% of Si, 0.5 to 1.5% of Al, 0.3 to 1.5% of Mn, 0.01 to 0.15% of Cr, 0.003 to 0.08% of Sn, 0.003 to 0.06% of Sb, and a balance of Fe and inevitable impurities, satisfying Formula 1 below, and
comprising a surface portion present from a surface of the steel sheet to 1/10 of a thickness of the steel sheet in a direction from the surface of the steel sheet toward an inside of the steel sheet, and a central portion,
wherein when the non-oriented electrical steel sheet is punched, a length of a plastically deformed portion is 100 μm or less, the plastically deformed portion referring to a length of a portion from a punched end portion where hardness of the surface portion exceeds 1.10 times that of the central portion.
$$0.03 \leq ( [ Cr ] + [ Sn ] + [ Sb ] ) \leq 0.2 \qquad [ Formula 1 ]$$
(in Formula 1, [Cr], [Sn], and [Sb] indicate contents (wt %) of Cr, Sn, and Sb, respectively.)

2. The non-oriented electrical steel sheet of claim 1, further containing 0.01 to 0.2 wt % of Cu.

3. The non-oriented electrical steel sheet of claim 1, further containing one or more of
0.08 wt % or less of P, 0.03 wt % or less of Mo, 0.0050 wt % or less of B, 0.0050 wt % or less of Ca, and 0.0050 wt % or less of Mg.

4. The non-oriented electrical steel sheet of claim 1, further containing
0.005 wt % or less of one or more of C, N, S, Ti, Nb, and V.

5. The non-oriented electrical steel sheet of claim 1, wherein:
a surface roughness of the steel sheet is 0.15 to 0.35 μm.

6. The non-oriented electrical steel sheet of claim 1, wherein:
the hardness of the surface portion is 1.05 to 1.10 times that of the central portion.

7. A method for manufacturing a non-oriented electrical steel sheet, the method comprising:
manufacturing a hot-rolled sheet by hot rolling a slab containing, by wt %: 3.1 to 3.8% of Si, 0.5 to 1.5% of Al, 0.3 to 1.5% of Mn, 0.01 to 0.15% of Cr, 0.003 to 0.08% of Sn, 0.003 to 0.06% of Sb, and a balance of Fe and inevitable impurities, and satisfying Formula 1 below;
manufacturing a cold-rolled sheet by cold rolling the hot-rolled sheet; and
subjecting the cold-rolled sheet to cold-rolled sheet annealing,
wherein the annealing the cold-rolled sheet comprises a first temperature raising treatment of raising a temperature of the cold-rolled sheet from 200° C. to 500° C., a second temperature raising treatment of raising the temperature of the cold-rolled sheet from higher than 500° C. to lower than a soaking temperature, and a soaking treatment, and
wherein Formula 2 below is satisfied.
$$0.03 \leq ( [ Cr ] + [ Sn ] + [ Sb ] ) \leq 0.2 \qquad [ Formula 1 ]$$
$$[ Formula 2 ]$$
$$\{ ( [ Cr ] + [ Sn ] + [ Sb ] ) \times [ sheet thickness ] \} / \{ ( [ Si ] + [ Al ] ) \times [ sheet roughness ] \} \leq [ DP ]$$
(in Formulas 1 and 2, [Si], [Al], [Cr], [Sn], and [Sb] indicate contents (wt %) of Si, Al, Cr, Sn, and Sb, respectively, [sheet thickness] indicates a sheet thickness (μm) of the cold-rolled sheet after the manufacturing the cold-rolled sheet, [sheet roughness] indicates a surface roughness (μm) of the cold-rolled sheet after the manufacturing the cold-rolled sheet, and [DP] indicates a dew point (° C.) in the first temperature raising treatment.)

8. The method of claim 7, wherein:
after the manufacturing the cold-rolled sheet, the surface roughness of the cold-rolled sheet is 0.15 to 0.35 μm.

9. The method of claim 7, wherein:
the dew point in the first temperature raising treatment is 0 to 50° C.

10. The method of claim 7, wherein:
the dew point in the second temperature raising treatment and the soaking treatment is −30 to 10° C.
